(19) United States
(12) Patent Application Publication
(10) Pub. No.: US 2017/0010983 A1
(43) Pub. Date: Jan. 12, 2017

(54) INPUT DEVICE IDENTIFYING COMPUTER SYSTEM AND IDENTIFICATION METHOD THEREOF

(71) Applicant: DEXIN CORPORATION, New Taipei City (TW)

(72) Inventor: Yuan Jung CHANG, New Taipei City (TW)

(21) Appl. No.: 15/045,942

(22) Filed: Feb. 17, 2016

(30) Foreign Application Priority Data
Jul. 6, 2015 (TW) 104121831

(51) Int. Cl. G06F 13/10; G06F 3/14; G06F 13/42; G06F 13/20; G06F 13/40

(52) U.S. Cl. CPC G06F 13/102; G06F 13/20; G06F 13/4068; G06F 13/4282; G06F 3/14

(57) ABSTRACT

An input device identifying a computer system includes: a memory, for storing a configuration descriptor, an interface descriptor, a human interface device descriptor and an end point descriptor; and a microprocessor, where when the input device is connected to a universal serial bus interface of the computer system, the microprocessor performs transmission of a communications protocol with the computer system by using multiple descriptors stored in the memory including the configuration descriptor, the interface descriptor, the human interface device descriptor, and the end point descriptor, and the microprocessor determines a type of the computer system according to a feature parameter associated with the multiple descriptors in the communications protocol. The present invention also provides an identification method of an input device identifying a computer system.

### BACKGROUND

Technical Field

The present invention relates to a peripheral device of a computer, and in particular, to an input device identifying a computer system and an identification method thereof.

Related Art

An input device is a conventional device of peripheral devices of a computer, and a keyboard and a mouse are common input devices. There are various types of mouses, such as a Serial Mouse, a PS/2 Mouse, and a Bus Mouse. These mouses have different communications protocols with the computer, and current mouse drivers are written for a certain specific mouse.

Different operation behaviors are made for different computer systems, and therefore, communications protocols between a mouse and different computer systems are different, for example, a coordinate system of Windows Wheel is different from a coordinate system of Mac, that is, a start position of the coordinate system of Windows Wheel is opposite to a start position of the coordinate system of Mac, and when a mouse is connected to the Windows computer system or the Mac computer system, the mouse cannot know to which computer system it is connected, and therefore, when the mouse executes an operation such as rolling up and down, rolling display of Windows is opposite to rolling display of Mac, so that a user of the mouse is rather inconvenient when operating at different computer systems.

### SUMMARY

In view of the above problem, an objective of the present invention is to provide an input device identifying a computer system and an identification method thereof. The input device determines, according to a feature parameter in a communications protocol with a computer system, a type of the computer system connected to the input device, so as to adjust a driver of the input device to be matched with the computer system, such that a user using the input device still has the same operation without considering which computer system is connected to, and additionally, the input device displays the type of the connected computer system, so as to add a function of notifying the user.

A first aspect of the present invention provides an input device identifying a computer system, including:
a memory, for storing a configuration descriptor, an interface descriptor, a human interface device descriptor, and an end point descriptor; and
a microprocessor, where when the input device is connected to a universal serial bus interface of the computer system, the microprocessor performs transmission of a communications protocol with the computer system by using multiple descriptors stored in the memory including the configuration descriptor, the interface descriptor, the human interface device descriptor, and the end point descriptor, and the microprocessor determines a type of the computer system according to a feature parameter associated with the multiple descriptors in the communications protocol.

A second aspect of the present invention provides an identification method of an input device identifying a computer system, and in a situation that the input device is connected to a universal serial bus interface of the computer system, the identification method includes the following steps:
performing by a microprocessor of the input device, transmission of a communications protocol with the computer system by using multiple descriptors stored in a memory of the input device including a configuration descriptor, an interface descriptor, a human interface device descriptor, and an end point descriptor; and
determining, by the microprocessor, a type of the computer system according to a feature parameter associated with the multiple descriptors in the communications protocol.

### BRIEF DESCRIPTION OF THE DRAWINGS

The disclosure will become more fully understood from the detailed description given herein below for illustration only, and thus are not limitative of the disclosure, and wherein:

FIG. 1 is a block diagram of a mouse connecting to a computer system according to the present invention; and

FIG. 2 is a flow chart of an identification method of a mouse identifying a computer system according to the present invention.

### DETAILED DESCRIPTION

In order that a person of ordinary skill in the art can further understand the present invention, construction content of the present invention and to-be-achieved affects are described in detail through preferred embodiments of the present invention listed hereinafter and the accompanying drawings.

Input devices in peripheral devices of a computer system include devices such as a mouse and a keyboard, and the input device in this embodiment uses a mouse as an example for description; however, it is not intended to limit the present invention, and any input device having a key is applicable to the present invention.

A function of a Universal Serial Bus (USB) device is that, before being used, the computer system first acquires configuration data from the USB device, and sends an instruction to set a configuration, where the setting a configuration refers to selecting a selectable setting option in the configuration data.

Each USB device at least has one configuration, and selects a configuration number by using a configuration setting instruction, so as to complete the configuration setting. The same USB device may use different drivers to set different configurations, and therefore, the USB device may have completely different usages.

The computer system acquires descriptor data of the USB device by acquiring a descriptor instruction. According to the USB specification, when it is instructed to acquire a configuration descriptor, the USB device needs to transmit data such as a device descriptor, an interface descriptor, a Human Interface Device (HID) descriptor and an end point descriptor to the computer system.

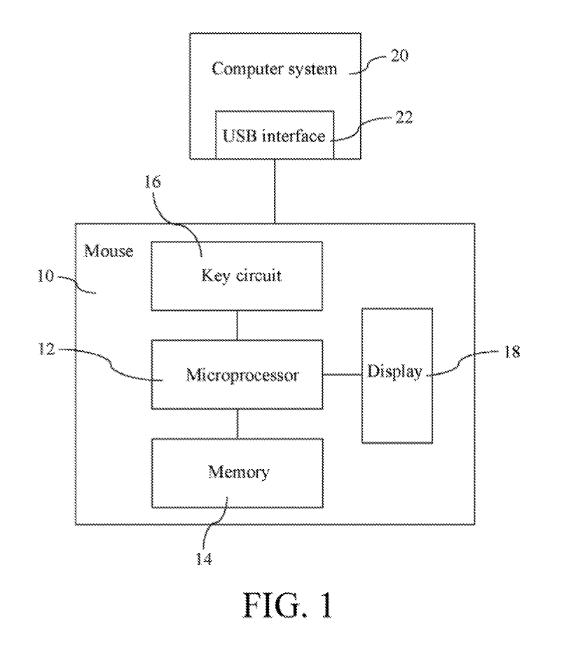

FIG. 1 is a block diagram of a mouse connecting to a computer system according to the present invention. In FIG. 1, it can be considered that a mouse 10 of the USB device is connected to a USB interface 22 of the computer system 20, and the mouse 10 includes a microprocessor 12, a memory 14, a key circuit 16 and a display 18. The key circuit 16 includes at least one key (not shown).

The memory 14 stores data such as the device descriptor, the interface descriptor, the HID descriptor, and the end point descriptor.

When the mouse 10 is connected to the USB interface 22 of the computer system 20, the computer system 20 sends, through the USB interface 22, a descriptor acquire instruction to the microprocessor 12 of the mouse 10, the microprocessor 12 transmits, according to the descriptor acquire instruction, multiple descriptors stored in the memory 14 such as the configuration descriptor, the interface descriptor, the HID descriptor and the end point descriptor to the computer system 20, so as to perform transmission of a communications protocol.

The computer system 20 requires the mouse 10 to transmit a feature parameter associated with the multiple descriptors, however, for example, the Windows computer system and the Mac computer system require the mouse 10 to transmit different feature parameters associated with the multiple descriptors, and therefore, the microprocessor 12 determines, according to the feature parameter associated with the multiple descriptors in the communications protocol, whether the computer system 20 is the Windows computer system or the Mac computer system.

After the microprocessor 12 determines whether the computer system 20 is the Windows computer system or the Mac computer system or another type of computer system, the microprocessor 12 sends a display signal to the display 18, so that the display 18 displays the type of the computer system 20 connected to the mouse 10. The display function of the mouse 10 is an optional function, and the display 18 may be disposed on the mouse 10 according to the requirement.

After the type of the computer system 20 connected to the mouse 10 is acquired, the computer system 20 may access, from a record medium (such as a hard disk, an optical disc, and a flash drive), and execute a driver of the mouse 10 corresponding to the type of the computer system 20. In another embodiment, when a key (not shown) of the key circuit 16 is pressed, the key circuit 16 sends a key signal to the microprocessor 12, such that the microprocessor 12 reads a network address from the memory 14 to transmit the network address to the computer system 20, the network address corresponding to the type of the computer system 20, and the computer system 20 downloads a driver of the mouse 10 according to the network address and executes the driver.

As described above, after the microprocessor 12 determines the type of the computer system 20, the driver of the mouse 10 is adjusted to be matched with an operation of the computer system 20, such that a user of the mouse 10 can still have the same operation without considering which type of computer system is connected to.

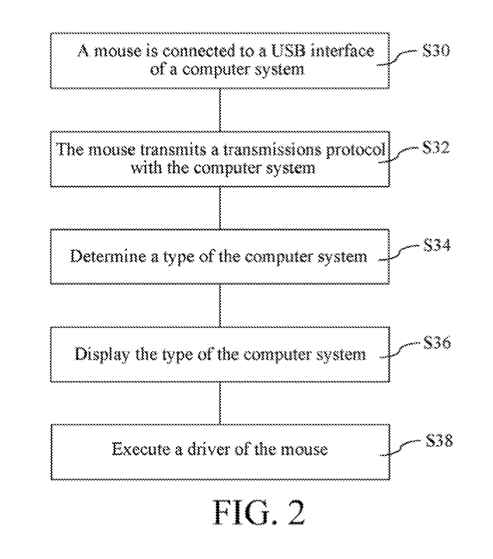

FIG. 2 is a flow chart of an identification method of a mouse identifying a compute system. Steps of FIG. 2 are described with reference to the components of FIG. 1.

The mouse 10 is connected to the USB interface 22 of the computer system 20 (step S30). When the computer system 20 detects that the mouse 10 is connected to the USB interface 22, the computer system 20 sends, through the USB interface 22, a descriptor acquire instruction to the microprocessor 12 of the mouse 10, and the microprocessor 12 transmits, according to the descriptor acquire instruction, multiple descriptors stored in the memory 14 such as the configuration descriptor, the interface descriptor, the HID descriptor and the end point descriptor to the computer system 20, so as to perform transmission of a communications protocol with the computer system 20 (step S32).

The computer system 20 requires the mouse 10 to transmit a feature parameter associated with the multiple descriptors, and different computer systems 20 require the mouse 10 to transmit different feature parameters associated with the multiple descriptors, and therefore, the microprocessor 12 determines the type of the computer system 20 (for example, whether it is the Windows computer system or the Mac computer system) according to the feature parameter associated with the multiple descriptors in the communications protocol (step S34).

After the microprocessor 12 determines whether the computer system 20 is the Windows computer system or the Mac computer system or another type of computer system, the microprocessor 12 transmits a display signal to the display 18, such that the display 18 displays the type of the computer system 20 connected to the mouse 10 (step S36). In this embodiment, the display function of the mouse 10 is optional as required.

After the type of the computer system 20 connected to the mouse 10 is acquired, the computer system 20 may access, from a record medium (such as a hard disk, an optical disc, and a flash drive), and execute a driver of the mouse 10 corresponding to the type of the computer system 20. In another embodiment, when a key (not shown) of the key circuit 16 is pressed, the key circuit 16 sends a key signal to the microprocessor 12, such that the microprocessor 12 reads a network address from the memory 14 to transmit the network address to the computer system 20, the network address corresponding to the type of the computer system 20, and the computer system 20 downloads a driver of the mouse 10 according to the network address and executes the driver (step S38). Therefore, the driver of the mouse 10 is adjusted to be matched with the operation of the computer system 20, such that the user of the mouse 10 can still have the same operation without considering which type of computer system is connected to.

The present invention provides an input device identifying a computer system and an identification method thereof, which are characterized in that the input device determines, according to the feature parameter in the communications protocol of the computer system, the type of the computer system to which the input device is connected, and further adjusts the driver of the input device to be matched with the operation of the computer system, such that the user of the input device can still have the same operation without considering which type of computer system is connected to, and additionally, the input device displays the type of the connected computer system, so as to add a function of notifying the user.

Although the present invention has been described with reference to the preferred embodiment and exemplary accompanying drawings in the foregoing, it should not be considered as limitation of the present invention. Various modifications, omissions and variations made by a person skilled in the art on the configuration and content of the embodiment do not depart from the scope of the claims of the present invention.

What is claimed is:

1. An input device identifying a computer system, comprising:
a memory, storing a configuration descriptor, an interface descriptor, a human interface device descriptor, and an end point descriptor; and
a microprocessor, wherein when the input device is connected to a universal serial bus interface of the computer system, the microprocessor performs transmission of a communications protocol with the computer system by using multiple descriptors stored in the memory comprising the configuration descriptor, the interface descriptor, the human interface device descriptor, and the end point descriptor, and the microprocessor determines a type of the computer system according to a feature parameter associated with the multiple descriptors in the communications protocol.

2. The input device according to claim 1, further comprising a key circuit, wherein when a key of the key circuit is pressed, the key circuit sends a key signal to the microprocessor, such that the microprocessor reads a network address from the memory to transmit the network address to the computer system, wherein the network address corresponds to the type of the computer system.

3. The input device according to claim 1, further comprising a display, wherein the microprocessor transmits a display signal to the display, such that the display displays the type of the computer system.

4. The input device according to claim 1, wherein, the computer system executes a driver of the computer system corresponding to the input device.

5. An identification method of an input device identifying a computer system, wherein in a situation that the input device is connected to a universal serial bus interface of the computer system, the identification method comprises the following steps:
performing, by a microprocessor of the input device, transmission of a communications protocol with the computer system by using multiple descriptors stored in a memory of the input device including a configuration descriptor, an interface descriptor, a human interface device descriptor, and an end point descriptor; and
determining, by the microprocessor, a type of the computer system according to a feature parameter associated with the multiple descriptors in the communications protocol.

6. The identification method according to claim 5, after the step of determining, by the microprocessor, a type of the computer system, further comprising the following step:
transmitting, by the microprocessor, a display signal to a display of the input device, such that the display displays the type of the computer system.

7. The identification method according to claim 5, after the step of determining, by the microprocessor, a type of the computer system, further comprising the following step:
when one key of the input device is pressed, sending, by a key circuit of the input device, a key signal to the microprocessor, such that the microprocessor reads a network address from the memory to transmit the network address to the computer system.

8. The identification method according to claim 5, after the step of determining, by the microprocessor, a type of the computer system, further comprising the following step:
executing, by the computer system, a driver of the computer system corresponding to the input device.
